(19) United States
(12) Patent Application Publication
(10) Pub. No.: US 2020/0200638 A1
(43) Pub. Date: Jun. 25, 2020

(54) TIRE INSPECTION METHOD AND TIRE INSPECTION APPARATUS

(71) Applicant: Toyo Tire Corporation, Itami-shi (JP)

(72) Inventor: Shuhei Ito, Itami-shi (JP)

(73) Assignee: Toyo Tire Corporation, Itami-shi (JP)

(21) Appl. No.: 16/708,762

(22) Filed: Dec. 10, 2019

(30) Foreign Application Priority Data
Dec. 25, 2018 (JP) 2018-240776

(51) Int. Cl. G01M 1/16; G01M 1/34; G01N 22/02

(52) U.S. Cl. CPC G01M 1/16; G01N 22/02; G01M 1/34

(57) ABSTRACT

For a vulcanized tire, after executing a third inspection step of inspecting an internal defect, a first inspection step of inspecting uniformity and a second inspection step of inspecting dynamic balance are executed. For the tire of which an internal defect is detected in the third inspection step, the first inspection step and the second inspection step are not executed and the inspection is over.

### TECHNICAL FIELD

The present invention relates to a tire inspection method and a tire inspection apparatus.

### BACKGROUND ART

For a vulcanized tire, a plurality of product inspections on uniformity, dynamic balance and the like are performed. It is important to efficiently perform the inspections in a short time so as to increase production efficiency of the tire. Therefore, a tire inspection apparatus for efficient inspection is suggested (for example, refer to PTL 1).

JP-A-2010-101725 discloses a tire inspection apparatus that includes two spindle shafts for rotatably supporting tires and one rotary drum configured to reciprocally move between the two spindle shafts and to contact any of the tires attached to the spindle shafts, and is configured to measure uniformity of the tire, which is in contact with the rotary drum, of the tires attached to the two spindle shafts and to measure dynamic balance of the tire, which is not in contact with the rotary drum.

In the tire inspection apparatus of JP-A-2010-101725, while measuring the uniformity of the tire attached to one spindle shaft, the dynamic balance of the tire attached to the other spindle shaft is measured. Thereby, it is possible to measure the dynamic balance of the tire attached to the other spindle shaft while efficiently using standby time of the measurement of the uniformity.

In the meantime, since the tire is manufactured by stacking a plurality of members, the air or foreign matters may remain between the respective layers. The tire in which the air or foreign matters remain should be discarded as a defective product. In the related art, it is suggested to detect a tire internal defect in a non-destructive manner by using a non-destructive inspection apparatus (for example, refer to JP-A-2018-77192).

### SUMMARY OF THE INVENTION

In the related art, the tire internal defect is detected after the inspections on the uniformity, the dynamic balance and the like. However, since a tire having a defect therein cannot be corrected and is thus discarded, the inspections on the uniformity, the dynamic balance and the like performed for the tire having a defect therein are useless.

It is therefore an object of the present invention to provide a tire inspection method and a tire inspection apparatus capable of efficiently inspecting a vulcanized tire without performing useless inspections.

A tire inspection method of the present invention is a tire inspection method including executing, on a vulcanized tire, a first inspection step of inspecting uniformity, a second inspection step of inspecting dynamic balance, and a third inspection step of inspecting an internal defect, wherein the first inspection step and the second inspection step are executed after executing the third inspection step.

A tire inspection apparatus of the present invention is a tire inspection apparatus including a first inspection part configured to inspect uniformity, a second inspection part configured to inspect dynamic balance, and a third inspection part configured to inspect a tire internal defect, for a vulcanized tire, and a control unit configured to control the first inspection part, the second inspection part and the third inspection part, wherein the control unit is configured to inspect the tire in the first inspection part and the second inspection part after inspecting the tire in the third inspection part.

According to the present invention, it is possible to efficiently inspect the vulcanized tire without performing useless inspections.

### BRIEF DESCRIPTION OF THE DRAWINGS

FIG. 1 is an overall schematic plan view of a tire inspection apparatus in accordance with an exemplary embodiment of the present invention.

FIG. 2 is a schematic side view of a first inspection part and a third inspection part.

FIG. 3 is a schematic side view of a second inspection part.

FIG. 4 is a block diagram depicting a control configuration of the tire inspection apparatus.

FIG. 5 is a flowchart depicting a tire inspection method in the tire inspection apparatus of FIG. 1.

FIG. 6 is an overall schematic plan view of a tire inspection apparatus in accordance with a modified embodiment of the present invention.

### DETAILED DESCRIPTION OF THE INVENTION

### First Exemplary Embodiment

Hereinbelow, a first exemplary embodiment of the present invention will be described with reference to the drawings.

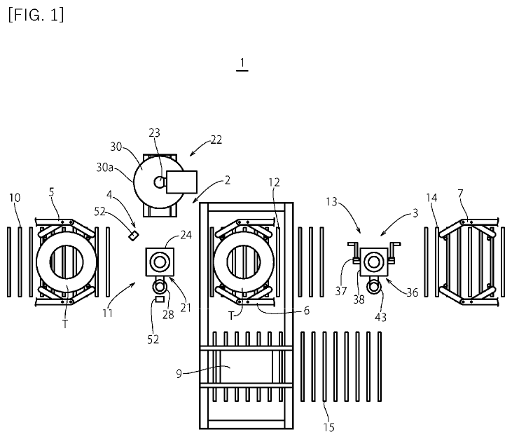

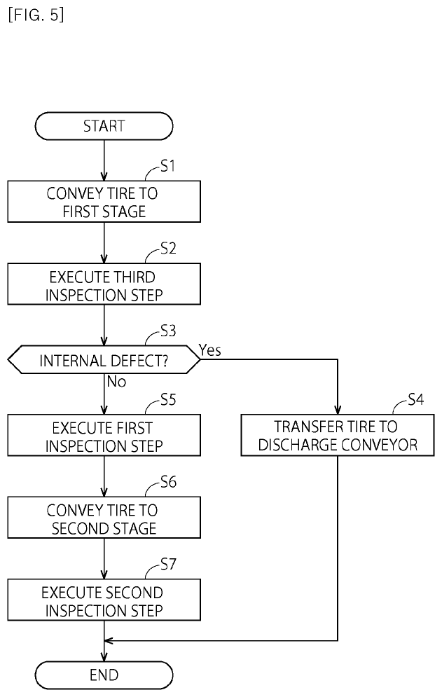

As shown in FIG. 1, a tire inspection apparatus 1 of the exemplary embodiment includes a first inspection part 2, a second inspection part 3, a third inspection part 4, conveying means 5, 6, 7, a transfer device 9, conveyors 10, 12, 14, a discharge conveyor 15, and a control unit 8 (refer to FIG. 4) configured to control the above elements. The tire inspection apparatus 1 is configured to inspect uniformity of a vulcanized tire (hereinbelow, also simply referred to as tire) T in the first inspection part 2, to inspect dynamic balance in the second inspection part 3, and to inspect an internal defect in the third inspection part 4.

In the tire inspection apparatus 1, a first stage 11 including the first inspection part 2 and the third inspection part 4 is provided between the conveyor 10 and the conveyor 12, and a second stage 13 including the second inspection part 3 is provided between the conveyor 12 and the conveyor 14. Also, the tire inspection apparatus 1 is provided with a discharge conveyor 15 in parallel to the conveyor 12 configured to interconnect the first stage 11 and the second stage 13. The tire inspection apparatus 1 is configured to transfer a tire T on the conveyor 12 to the discharge conveyor 15 by the transfer device 9.

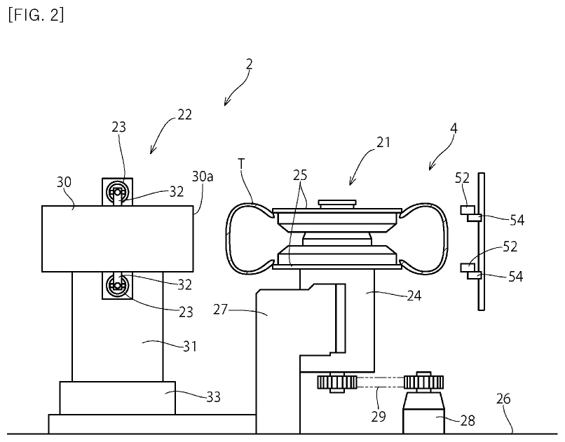

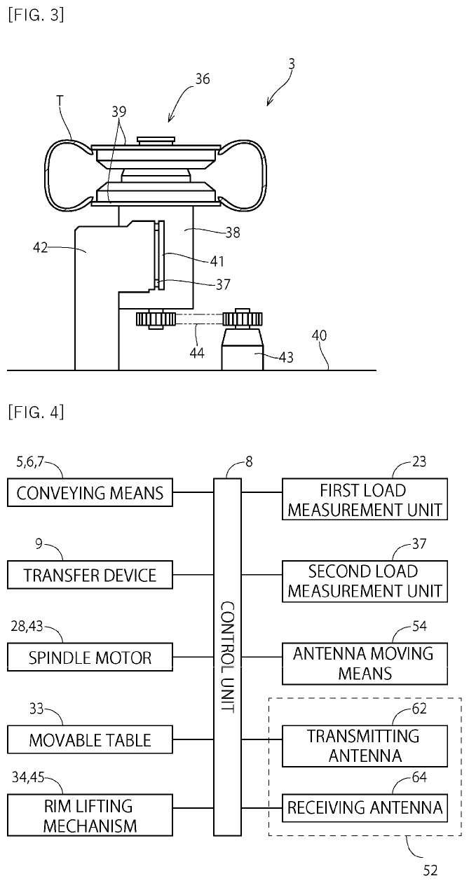

As shown in FIG. 2, the first inspection part 2 includes a spindle shaft 21, a rotary drum mechanism 22, and a first load measurement unit 23, and is configured to measure uniformity of the tire T as a first inspection step.

The spindle shaft 21 has a cylindrical shape of which a shaft center is directed vertically, and is rotatably supported to a housing 24. An upward protruding part of the spindle shaft 21 is provided with a pair of upper and lower rims 25 for fixing the tire T. An outer peripheral surface of the housing 24 is provided with a housing support member 27 for fixing the housing 24 to a base 26.

The upper rim 25 of the pair of upper and lower rims 25 is provided to be vertically movable by a rim lifting mechanism 34 (refer to FIG. 4). The upper rim 25 is configured to move toward the lower rim 25 fixed to the spindle shaft 21 for holding the tire T between the upper rim 25 and the lower rim 25. Also, the rim lifting mechanism 34 is configured to move up the upper rim 25 from a position, in which the tire T is held, thereby releasing the holding state of the tire T.

The spindle shaft 21 is configured to rotate the tire T held by the rims 25 around an axis of the tire as drive force is transmitted thereto from a spindle motor 28 via a timing belt 29. On a side spaced from the spindle shaft 21 by a predetermined interval, a rotary drum mechanism 22 configured to freely move toward and away from in a horizontal direction is provided.

The rotary drum mechanism 22 includes a drum part 30 having a cylindrical outer shape of which an outer peripheral surface is formed with a simulation road surface 30a to which the tire T is to be contacted, and a drum support body 31 configured to rotatably support the drum part 30.

The drum part 30 is provided in a position facing the rims 25 of the spindle shaft 21, and is configured to rotate around a shaft part 32 (shaft center) protruding upward and downward.

The drum support body 31 is configured to support the drum part 30 so as to rotate the same around the vertical shaft center, and is arranged to move toward and away from in the horizontal direction by a movable table 33. The drum support body 31 is configured to bring the simulation road surface 30a of the drum part 30 into contact with the tire T attached to the spindle shaft 21.

The first load measurement unit 23 configured by a load cell is provided between the rotary drum mechanism 22 and the drum support body 31. The first load measurement unit 23 is configured to measure force to be applied to the drum support body 31 from the drum part 30 in contact with the tire T, and to output a measurement result to the control unit 8. The control unit 8 is configured to calculate uniformity from the measurement result input from the first load measurement unit 23.

The second inspection part 3 includes a spindle shaft 36, and a second load measurement unit 37, and is configured to measure dynamic balance of the tire T as a second inspection step.

As with the spindle shaft 21 provided to the first inspection part 2, the spindle shaft 36 has a cylindrical shape around a shaft center directed vertically, and is rotatably supported to a housing 38.

An outer peripheral surface of the housing 38 is provided with a housing support member 41 for fixing the housing 38 to a base 40. The housing support member 41 has a plate shape extending in the vertical direction and the horizontal direction.

An upward protruding part of the spindle shaft 36 is provided with a pair of upper and lower rims 39 for fixing the tire T. The upper rim 39 of the pair of upper and lower rims 39 is provided to be vertically movable by a rim lifting mechanism 45 (refer to FIG. 4). The upper rim 39 is configured to move toward the lower rim 39 fixed to the spindle shaft 36 for holding the tire T between the upper rim 39 and the lower rim 39. Also, the rim lifting mechanism 45 is configured to move up the upper rim 39 from a position, in which the tire T is held, thereby releasing the holding state of the tire T.

The spindle shaft 36 is configured to rotate the tire T held by the rims 39 around the axis of the tire as drive force is transmitted thereto from a spindle motor 43 via a timing belt 44.

The second load measurement unit 37 is configured by two load cells (piezoelectric elements), which are attached with being spaced vertically between the housing support member 41 and a positioning member 42. The second load measurement unit 37 is configured to measure a force component in a radial direction of the tire, which is applied to the base 40 from the housing 38 when rotating the tire T not in contact with the drum part 30 and the like at higher speed than upon the measurement of the uniformity, and to input a measurement result to the control unit 8. The control unit 8 is configured to calculate dynamic balance, based on the measurement result input from the second load measurement unit 37.

The third inspection part 4 includes a rotation means 21, a transmitting and receiving antenna unit 52, and an antenna moving means 54, and is configured to inspect an internal defect of the tire T in a non-destructive manner, as a third inspection step.

The rotation means 21 is to rotate the tire T in a state in which a rotary shaft is directed vertically. In the present example, the spindle shaft 21 provided to the first inspection part 2 is used.

The transmitting and receiving antenna unit 52 includes a transmitting antenna 62 configured to output a microwave to be irradiated to the tire T, and a receiving antenna 64 spatially separated from the transmitting antenna and configured to receive a reflected wave of the microwave from the tire T (refer to FIG. 4). The transmitting and receiving antenna unit 52 is arranged in plural (two, in the exemplary embodiment) with being spaced in a width direction of the tire T held by the rims 25 of the spindle shaft 21.

The microwave to be irradiated from the transmitting antenna 62 to a to-be-measured object includes a frequency of causing interference by multiple reflection between a surface of the to-be-measured object and a defect. When an intensity of the reflected wave at the frequency is measured at the receiving antenna 64, an internal defect of the to-be-measured object can be detected. In the meantime, the frequency of the microwave can be selected in a band ranging from 300 MHz to 300 GHz. Also, an irradiation range of the microwave by the transmitting antenna 62 is not particularly limited, and a defect can be detected in a range of about 30 mm², in the present example.

The transmitting antenna 62 and the receiving antenna 64 are connected to the control unit 8. The control unit 8 is configured to generate a wave source of the microwave to be output from the transmitting antenna 62 and to generate a detection signal from the reflected wave received at the receiving antenna 64.

In the meantime, the specific configuration for executing generation of a wave source of the microwave and generation of a detection signal in the control unit 8 is not particularly limited. For example, the control unit 8 includes a fixed oscillator, a sweep oscillator (local oscillator), a mixer, a frequency filter, an IQ mixer and the like. The control unit 8 is configured to generate a transmission wave by multiplexing a signal of a sweep frequency generated by the sweep oscillator to a signal generated by the fixed oscillator configured to transmit a microwave of a fixed frequency, and to output the transmission wave from the transmitting antenna 62. A receiving circuit is configured in a heterodyne manner. The receiving circuit is configured to transmit a localized wave, which is a microwave of a frequency different from the frequency of the microwave output from the transmitting antenna 62, by using the sweep oscillator as a local oscillator. The receiving circuit is configured to multiplex the localized wave and the received signal received at the receiving antenna 64 in the mixer, to generate a difference frequency signal having a difference frequency of both the frequencies, and to cause the same to pass through the frequency filter, thereby obtaining only a difference frequency signal. This signal is input to the IQ mixer, as a measurement signal, which is then multiplexed with a reference wave signal of the frequency of the fixed oscillator in the IQ mixer and a detection signal is thus obtained.

The antenna moving means 54 is configured to move the transmitting and receiving antenna unit 52 in the width direction of the tire (vertical direction), and to irradiate the microwave over an entire width of the tire T held by the rims 25.

The control unit 8 is configured by a computer including a calculation processing unit, a memory, and a display. As shown in FIG. 4, the control unit 8 is connected to the conveying means 5, 6 and 7, the transfer device 9, the spindle motors 28 and 43, the movable table 33, the rim lifting mechanisms 34 and 45, the first load measurement unit 23, the second load measurement unit 37, the transmitting and receiving antenna unit 52, and the antenna moving means 54, and is configured to control operations thereof. Also, the control unit 8 is configured to calculate the uniformity from the measurement result input from the first load measurement unit 23, to calculate the dynamic balance from the measurement result input from the second load measurement unit 37, and to detect whether there is an internal defect in the tire T from the measurement result input from the receiving antenna 64.

Subsequently, operations of the tire inspection apparatus 1 are described with reference to FIG. 5.

First, a feeder (not shown) places the tire T on the conveyor 10, and the tire T is conveyed to a position, in which the tire can be gripped by the conveying means 5, by the conveyor 10. Then, the conveying means 5 conveys the tire T to the spindle shaft 21 provided to the first stage 11 while gripping the tire T, and the tire T is held between the pair of upper and lower rims 25 (step S1 in FIG. 5).

Then, the third inspection part 4 is operated to execute the third inspection step of inspecting the internal defect of the tire T in a non-destructive manner (step S2 in FIG. 5).

Specifically, while rotating the tire T by the spindle shaft 21, the microwave is output by the transmitting antenna 62 and the reflected wave is received by the receiving antenna 64. The output of the microwave and the reception of the reflected wave are performed until the measurement over an entire width of a tread part of the tire T is completed while moving the transmitting and receiving antenna unit 52 with a predetermined interval in the width direction of the tire by using the antenna moving means 54 whenever the tire T rotates one revolution. In the case in which the two transmitting and receiving antenna units 52 are provided with an interval in the width direction of the tire T, like the exemplary embodiment, the antenna moving means 54 moves the transmitting and receiving antenna units 52 in the width direction of the tire T by at least a half-length of the entire width of the tread part.

Then, the control unit 8 generates a detection signal from the reflected wave received at the receiving antenna 64, and detects whether there is a defect (air, foreign matters and the like), depending on whether an intensity of the generated detection signal exceeds a threshold value (step S3 in FIG. 5).

When the control unit 8 detects an internal defect of the tire T (step S3: Yes, in FIG. 5), the control unit releases the holding state of the tire T by the rims 25 without executing the first inspection step, conveys the tire T from the spindle shaft 21 to the conveyor 12 by the conveying means 6, transfers the tire T on the conveyor 12 to the discharge conveyor 15 by the transfer device 9, and discharges the tire T from the tire inspection apparatus 1 (step S4 in FIG. 5).

On the other hand, when the control unit 8 does not detect an internal defect of the tire T (step S3: No, in FIG. 5), the control unit executes the first inspection step of measuring the uniformity, subsequently to the third inspection step (step S5 in FIG. 5).

Specifically, the control unit 8 stops the rotation of the spindle shaft 21 to end the third inspection step, and brings the simulation road surface 30a of the drum part 30 into contact with the tire T while holding the tire T by the rims 25. Then, the control unit rotates the spindle shaft 21 at predetermined rotating speed (for example, 60 rpm as prescribed in JASO C607), thereby rotating the tire T attached to the spindle shaft 21 and also the drum part 30 in contact with the tire in a driven manner.

Then, the first load measurement unit 23 provided to the drum part 30 measures the force component applied to the shaft part 32 from the drum part 30, and measures the uniformity of the tire T attached to the spindle shaft 21.

Then, when the first inspection step is over, the control unit releases the holding state of the tire T by the rims 25, conveys the tire T from the spindle shaft 21 to the spindle shaft 36 provided to the second stage 13 by the conveying means 6, and holds the tire T between the pair of upper and lower rims 39 (step S6 in FIG. 5).

Then, the control unit operates the second inspection part 3 to execute the second inspection step of measuring the dynamic balance of the tire T (step S7 in FIG. 5).

Specifically, the control unit rotates the spindle shaft 36 at the larger number of rotations than the spindle shaft 21 in the first inspection step, and measures vibrations (shaking) generated in the tire T during the rotation, as the force component in the second load measurement unit 37, thereby measuring the dynamic balance of the tire T attached to the spindle shaft 36.

Then, when the second inspection step is over, the control unit releases the holding state of the tire T by the rims 39, conveys the tire T from the spindle shaft 36 to the conveyor 14 by the conveying means 7, and takes out the tire T from the tire inspection apparatus 1, so that all the inspections are over.

According to the exemplary embodiment as described above, after executing the third inspection step of inspecting the internal defect of the tire T, the first inspection step of inspecting the uniformity and the second inspection step of inspecting the dynamic balance are executed. Therefore, when the internal defect of the tire T, which is an inspection target, is detected in the third inspection step, the inspection is ended without executing the first inspection step and the second inspection step, so that it is possible to efficiently inspect the tire T without performing useless inspections.

Also, in the exemplary embodiment, the first inspection part 2 and the third inspection part 4 rotate the tire T, which is an inspection target, by using the same spindle shaft 21. Therefore, after the third inspection step is over, the first inspection step can be started while holding the tire T to the spindle shaft 21, so that it is possible to considerably shorten the time necessary to shift from the third inspection step to the first inspection step.

Also, in the exemplary embodiment, the third inspection step is executed while the tire T is held by the rims 25. Therefore, during the inspection, it is possible to arrange the tire T in a predetermined position and to make a distance from the transmitting and receiving antenna unit 52 to the tire surface constant, so that it is possible to detect the defect with accuracy.

### Modified Embodiments

In the first exemplary embodiment, the first inspection part 2 and the third inspection part 4 are provided to the first stage 11, and the first inspection step and the third inspection step are executed using the same spindle shaft 21. However, the present invention is not limited thereto. For example, the first inspection part 2, the second inspection part 3 and the third inspection part 4 may be provided to the first stage 11, and the first inspection step, the second inspection step and the third inspection step may be executed while holding the tire T to the same spindle shaft 21. Alternatively, the first inspection step and the third inspection step may be executed while holding the tire T to the different spindle shaft.

### Second Exemplary Embodiment

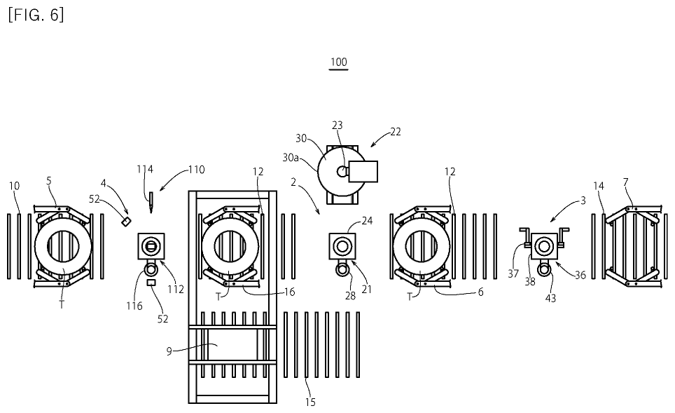

Subsequently, a second exemplary embodiment of the present invention is described with reference to FIG. 6. In the meantime, the same configurations as the first exemplary embodiment are denoted with the same reference signs, and the descriptions thereof are omitted.

A tire inspection apparatus 100 of the second exemplary embodiment includes a trimming device 110 configured to execute a trimming process of cutting spews (burrs formed as unvulcanized rubber protrudes from vent holes of a mold during vulcanization molding of a tire) formed on an outer peripheral surface of the tire T with a cutter, in addition to the first inspection part 2 configured to inspect the uniformity, the second inspection part 3 configured to inspect the dynamic balance, and the third inspection part 4 configured to inspect the internal defect.

The trimming device 110 includes a spindle shaft 112 configured to rotate the tire around the axis, and a spew cutter 114 configured to cut spews.

The spindle shaft 112 has a cylindrical shape of which a shaft center is directed vertically, like the spindle shaft 21 provided to the first inspection part 2. An upward protruding part of the spindle shaft 36 is provided with rims (not shown) for holding the tire T. The spindle shaft 112 is configured to rotate the tire T held by the rims around the axis of the tire as drive force is transmitted thereto from a spindle motor 116 via a timing belt.

The trimming device 110 is configured to remove the spews by bringing the spew cutter 114 close to a tread surface of the tire T while rotating the tire T held by the rims.

The spindle shaft 112 configuring the trimming device 110 also functions as the rotation means 21 of the third inspection part 4. That is, the transmitting and receiving antenna unit 52 configuring the third inspection part 4 is provided in the vicinity of the spindle shaft 112, and is configured to irradiate the microwave to the tire T held to the spindle shaft 112 and to receive the reflected wave from the tire T.

In the tire inspection apparatus 100, after a feeder (not shown) places the tire T on the conveyor 10, the conveying means 5 conveys the tire T to the spindle shaft 112 with gripping the same, and the tire T is held between the rims provided to the spindle shaft 112.

Then, the third inspection part 4 is operated to execute the third inspection step of inspecting the internal defect of the tire T in a non-destructive manner.

Then, the control unit 8 generates a detection signal from the reflected wave received at the receiving antenna 64, and detects whether there is a defect, depending on whether an intensity of the generated detection signal exceeds a threshold value.

When the control unit 8 detects an internal defect of the tire T, the control unit conveys the tire T from the spindle shaft 112 to the conveyor 12 by the conveying means without executing the trimming process, the first inspection step and the second inspection step, transfers the tire T on the conveyor 12 to the discharge conveyor 15 by the transfer device 9, and discharges the tire T from the tire inspection apparatus 1.

On the other hand, when the control unit 8 does not detect an internal defect of the tire T, the control unit executes the trimming process while holding the tire T with the spindle shaft 112, subsequently to the third inspection step. Then, when the trimming process is over, the control unit sequentially conveys the tire T to the spindle shafts 21 and 36 to sequentially execute the first inspection step and the second inspection step.

According to the second exemplary embodiment as described above, after executing the third inspection step of inspecting the internal defect of the tire T, the trimming process, the first inspection step of inspecting the uniformity and the second inspection step of inspecting the dynamic balance are executed. Therefore, when the internal defect of the tire T, which is an inspection target, is detected in the third inspection step, the inspection is ended without executing the trimming process, the first inspection step and the second inspection step, so that it is possible to efficiently inspect the tire T without performing useless inspections.

### Other Exemplary Embodiments

In the exemplary embodiments, when the measurement of the uniformity of the tire T is over in the first inspection part 2, the first inspection step is over, irrespective of the result thereof, and the process proceeds to the second inspection step. However, a correction process of correcting the uniformity of the tire T, depending on the inspection result of the first inspection step, may be executed.

For example, when the uniformity measured in the first inspection step satisfies a predetermined criterion, the first inspection step is ended to release the holding state of the tire T by the rims 25, the tire T is conveyed from the spindle shaft 21 to the spindle shaft 36 provided to the second stage 13 by the conveying means 6, and then the tire T is held between the pair of upper and lower rims 39.

On the other hand, when the measured uniformity does not satisfy the predetermined criterion, a correction process of grinding a surface (tread surface) of the tire T with a grinder to correct the uniformity of the tire T is executed. After executing the correction process, the first inspection step is again executed. When the uniformity satisfies the predetermined criterion, the first inspection step is ended, and when the measured uniformity does not satisfy the predetermined criterion, the correction process is again executed. When the uniformity measured in the first inspection step does not satisfy the predetermined criterion even though the correction process is executed by a predetermined number of times, the tire T is conveyed to the discharge conveyor 15 and is then discharged from the tire inspection apparatus.

In this way, when the correction process is executed before the second inspection step after the first inspection step, the third inspection step is executed before the first inspection step, so that it is possible to efficiently inspect the tire T without performing useless inspections.

Although the exemplary embodiments have been described, the exemplary embodiments are just exemplary and are not intended to limit the scope of the invention. The novel exemplary embodiments can be implemented in other various forms, and can be diversely omitted, replaced and changed without departing from the gist of the invention.

What is claimed is:

1. A tire inspection method comprising: executing, on a vulcanized tire, a first inspection step of inspecting uniformity, a second inspection step of inspecting dynamic balance, and a third inspection step of inspecting an internal defect,
wherein the first inspection step and the second inspection step are executed after executing the third inspection step.

2. The tire inspection method according to claim 1,
wherein the first inspection step and the second inspection step are not executed for a tire of which an internal defect is detected in the third inspection step.

3. A tire inspection apparatus comprising:
a first inspection part configured to inspect uniformity, a second inspection part configured to inspect dynamic balance, and a third inspection part configured to inspect an internal defect, for a vulcanized tire; and
a control unit configured to control the first inspection part, the second inspection part and the third inspection part,
wherein the control unit is configured to inspect the tire in the first inspection part and the second inspection part after inspecting the tire in the third inspection part.

4. The tire inspection apparatus according to claim 3,
wherein the first inspection part comprises a rotation means for rotating the tire around an axis of the tire while holding the same, and
wherein the third inspection part is configured to inspect an internal defect of the tire held by the rotation means.

5. The tire inspection apparatus according to claim 3, comprising a trimming device configured to cut spews formed on an outer surface of the tire while rotating the tire around an axis of the tire while holding the same,
wherein the third inspection part is configured to inspect an internal defect of the tire held by the trimming device.
